(19) United States
(12) Patent Application Publication
(10) Pub. No.: US 2012/0131189 A1
(43) Pub. Date: May 24, 2012

(54) APPARATUS AND METHOD FOR INFORMATION SHARING AND PRIVACY ASSURANCE

(75) Inventors: J. C. Smart, Clarksville, MD (US); Kimbry L. McClure, Garland, TX (US)

(73) Assignee: Raytheon Company, Waltham, MA (US)

(21) Appl. No.: 12/953,860

(22) Filed: Nov. 24, 2010

(51) Int. Cl. G06F 15/173; G06F 17/30

(52) U.S. Cl. 709/225; 707/792; 707/E17.099; 707/E17.045

(57) ABSTRACT

An apparatus for information privacy assurance includes a data processing engine to restrict access to data received from a plurality of data sources and to a predefined data relationship query. The data processing engine includes a data input component restricted to receive the data from the plurality of data sources, a data relationship component configured to generate data relationships associated with the data, a query input component restricted to receive the predefined data relationship query associated with the data relationships, a query execution component configured to execute the predefined data relationship query, and a data output component restricted to render a result including information associated with an execution of the predefined data relationship query.

### FIELD OF THE INVENTION

The inventive concepts, systems, and techniques described herein are directed to information protection and, more particularly, to information sharing and privacy assurance.

### BACKGROUND

The problem of sharing information across legal and jurisdictional boundaries while preventing unintended exposure of personally protectable information, classified information, confidential, and/or private information is a major, long felt obstacle in data mining such as examining information for indications of illegal activity or criminal intent or determining buying patterns. Ideally, private information must be shared in a manner that allows authorized users access to the information needed to readily support investigations or otherwise determine the required results. At the same time, however, sharing the information poses risks to exposure of the information, a problem that may be exacerbated by the reality that information originates from different sources over networks vulnerable to unauthorized access and/or despite efforts to block access to the information.

One of the most secure methods for protecting private information known as the “air gap” method is to keep the information in a secure facility, for example, a bunker or a guarded building physically isolated from the outside world. The protected information is typically maintained and accessed by users on a secret network (often referred to as a “red network”) within the secure facility. The air gap method blocks access to unprotected networks, often referred to as “black networks”, such as public networks, for example, the Internet.

Users within the secure facility, however, require access to outside information (e.g., electronic mail messages, files, and updates) downloaded from unprotected networks and so the air gap method often involves physically fetching the outside information from a black network and copying the information to a red network. More particularly, personnel may transfer the information from a black network to a data disk (e.g., a compact disc), carry the data disk into the secure facility, and copy the information from the data disk to a server accessible from the red network so that users can obtain the outside information.

As is known in the art, a firewall is a data protection and communications solution intended to block unauthorized access to information on private networks while permitting authorized communications between a private network and other networks. Firewalls permit or deny network communications based on a set of rules and criteria. Since firewalls can pass data from private networks to outside networks an unauthorized user may be able to gain access to private data by circumventing firewall protections. Firewalls may be particularly vulnerable if network administrators improperly configure the firewall or the firewall includes certain shortcomings, such as underlying security defects and/or programming defects.

A unidirectional network (which may be referred to as a “unidirectional security gateway” or “data diode”) allows data to pass in only one direction from one side of a network link (referred to as the “low” side) to another side of the network link (referred to as the “high” side). One particular advantage of a unidirectional network is that users on the high side of the network link may protect information from the low side of the network link while gaining access to network services and outside information, such as electronic mail messages, files, and/or system updates.

Various methods and/or devices may be used to implement a unidirectional network such as a network appliance or device allowing data to travel only in one direction (i.e., from the low side to the high side of the network appliance). These devices may be as simple as a modified fiber optic cable, with send and receive transceivers removed for one direction. Many commercial products rely on this basic design.

For example, the Fox DataDiode (manufactured by Fox-IT of Guildford, United Kingdom) includes a unidirectional network coupling and proxy servers to enable stateful interaction. The DataDiode is a separate hardware unit that uses a single fiber cable for sending packets from a black network to a red network, but no fiber cable for sending packets in the reverse direction from the red network to a black network. Along with these physical limitations, the DataDiode contains no logic or processing and is therefore incapable of providing access to data on the red network.

### SUMMARY OF THE INVENTION

In general overview, the concepts, systems, and techniques described herein enable information sharing and privacy assurance. Organizations may provide confidential and/or private information, for example, information related to a business's customers to a data processing engine that restricts and/or blocks access to the data from outside sources. Organizations may request data queries to reveal informative patterns in data and to derive information to aid in a variety of important tasks, although such queries maintain the privacy of the data. The information helps provide form, meaning, instruction, and function to the data and further provides a basis to analyze and understand the data within a context or domain. For example, law enforcement agencies may query the data to reveal certain patterns in the data indicative of criminal intent or activity, military organization may access data using a sensitive compartmented information facility (SCIF) to reveal important operational aspects of a military theater, marketing organizations may access the data to determine effectiveness of sales techniques, or privacy enforcement agencies may query the data to enforce privacy statutes and regulations.

In some embodiments, a data processing engine receives data from one or more data sources. The data sources may include those owned and operated by particular organizations that collect the data, for example, a retail business that collects online transaction information from their customers. The data processing engine also receives predefined data queries which are designed and intended to search for and reveal patterns in the data to generate information that may be particularly useful to organizations. The data processing engine restricts and/or blocks access to the predefined data queries from outside sources, and may receive the predefined queries from query sources authorized to generate and provide the queries. In some instances, the query sources include policy bodies including individuals tasked with generating data queries that comply with, for example, constitutional due process or regulatory requirements. Such queries may be particularly useful in contexts involving private information (i.e., information of a personal private nature) the exposure of which may violate constitutional requirements or privacy regulations

In these embodiments, the data processing engine generates data relationships associated with the data. For example, the data processing engine may use and/or define an ontology model including concepts and relationships associated with a problem domain or context. The data processing engine executes the predefined queries against the data relationships and renders results that may include pattern matches. For example, the data processing engine may render information including a set of terror suspects who fit a certain query profile designed and/or intended to reveal terrorist activity. The data processing engine restricts and/or blocks access to the results to outside organizations that are not authorized to receive the results.

In some embodiments, the data processing engine automatically executes predefined queries that may be event-based or timed at predetermined intervals. For example, the data processing engine can execute graph template pattern matching algorithms to revel data patterns without any human intervention. Such algorithms may be tied to domain-based data models, such as those based on a domain ontology.

In this way, the inventive concepts, systems, and techniques described herein can generate searches to reveal patterns of activity or matches across varied data sets. One particular example involves a law enforcement agency. For example, if a policeman, or civilian for that matter, observes two people dressed in heavy raincoats approaching a bank on a hot summer day then there exists a reasonable suspicion that the two people are about to engage in dangerous and/or illegal activity (i.e., they are about to rob the bank). Based on these observational criteria, the policeman may be able to initiate actions to prevent a crime, for example, stopping and searching the two people for firearms, calling for law enforcement backup, etc. Similar patterns of suspicious activity that may be well known by law enforcement agencies may be vetted by these agencies and applied using the concepts, systems, and techniques described herein to help promote and aid law-enforcement activities.

Advantageously, the information sharing and privacy assurance approaches described herein are highly scalable and can significantly aid and improve data pattern matching analysis and outcomes. In particular, as higher and higher volumes of information are integrated into a single source, what was once loosely connected information from disparate sources can become a critical mass of information and information variables that when properly queried can significantly increase the probability of finding pattern matches previously unforeseen.

Moreover, the concepts, systems, and techniques can integrate multiple classifications of information relatively seamlessly in a way that enables many different organizations to share (and more particularly, benefit from) other organizations' information. For example, the Federal Bureau of Investigation (FBI) which tends to own highly classified information may be able to share such information with less restrictive organizations, such as local law enforcement agencies. Another particular advantage of the inventive concepts, systems, and techniques described herein is that policy bodies (for example, civil rights organizations) can accept certain vetted search patterns and, moreover, the pattern match results revealed by such search patterns with little or no concern over how the data processing engine executes the searches because the underlying data is secure.

In one aspect, an apparatus for information privacy assurance includes a data processing engine to restrict access to data received from a plurality of data sources and to a predefined data relationship query. The data processing engine includes a data input component restricted to receive the data from the plurality of data sources, a data relationship component configured to generate data relationships associated with the data, a query input component restricted to receive the predefined data relationship query associated with the data relationships, a query execution component configured to execute the predefined data relationship query, and a data output component restricted to render a result including information associated with an execution of the predefined data relationship query.

In a further embodiment, the apparatus includes one or more of the following features: the data input component includes a unidirectional network controller configured to receive data over a network and to block access to the data on the data processing engine; the data is received from an authorized data source; the plurality of data sources generate the data according to predefined data protocols; an ontology model to define concepts and relationships associated with the data, wherein the data relationship component is configured to associate the data with the ontology model; the query input component includes a unidirectional network controller configured to receive information associated with the predefined data relationship query over a network and to block access to the information on the data processing engine; the predefined data relationship query is received from an authorized query source, and; the data output component includes a unidirectional network controller configured to render the result over a network and to block access to the result on the data processing engine.

In another aspect, a method for information sharing and privacy assurance includes receiving data from a plurality of data sources over a first unidirectional network controller, generating data relationships associated with the data, receiving a predefined data relationship query associated with the data relationships over a second unidirectional network controller, and rendering a result including information associated with an execution of the predefined data relationship query over a third unidirectional network controller.

In further embodiments, the method includes one or more of the following features: the first unidirectional network controller is configured to block access to the data over a network; the data is received from an authorized data source; the plurality of data sources generates the data according to predefined data protocols; generating an ontology model to define concepts and relationships associated with the data; the second unidirectional network controller is configured to block access to the predefined data relationship query over a network; the predefined data relationship query is received from an authorized query source, and; the third unidirectional network controller is configured to block access to the result over a network.

In a further aspect, a computer readable medium having encoded thereon software for information privacy assurance includes software instructions that when executed by a processor enable receiving data from a plurality of data sources over a first unidirectional network controller, generating data relationships associated with the data, receiving a predefined data relationship query associated with the data relationships over a second unidirectional network controller, and rendering a result including information associated with an execution of the predefined data relationship query over a third unidirectional network controller.

In a further embodiment the software instructions include one or more of the following features: configuring the first unidirectional network controller to block access to the data over a network; receiving the data from an authorized data source; generating an ontology model to define concepts and relationships associated with the data; configuring the second unidirectional network controller to block access to the predefined data relationship query over a network; receiving the predefined data relationship query from an authorized query source, and; configuring the third unidirectional network controller to block access to the result over a network.

### BRIEF DESCRIPTION OF THE DRAWINGS

The foregoing features of the concepts, systems, and techniques described herein may be more fully understood from the following description of the drawings in which:

FIG. 1 is a block diagram of an embodiment of an apparatus for information sharing and privacy assurance;

FIG. 2 is a diagram depicting data, data relationships, and query information associated with an exemplary embodiment of the inventive concepts, systems, and techniques described herein;

FIG. 3 is a block diagram of another embodiment of an apparatus for information sharing and privacy protection;

FIG. 4 is a flow diagram of an embodiment of a method for information sharing and privacy assurance;

FIG. 5 is a flow diagram of a more detailed embodiment of the method of FIG. 4 for receiving data;

FIG. 6 is a flow diagram of a more detailed embodiment of the method of FIG. 4 for generating search patterns;

FIG. 7 is a flow diagram of a more detailed embodiment of the method of FIG. 4 for rendering search results; and

FIG. 8 is a diagram showing an exemplary hardware and operating environment of a suitable computer for use with embodiments of the invention.

### DETAILED DESCRIPTION

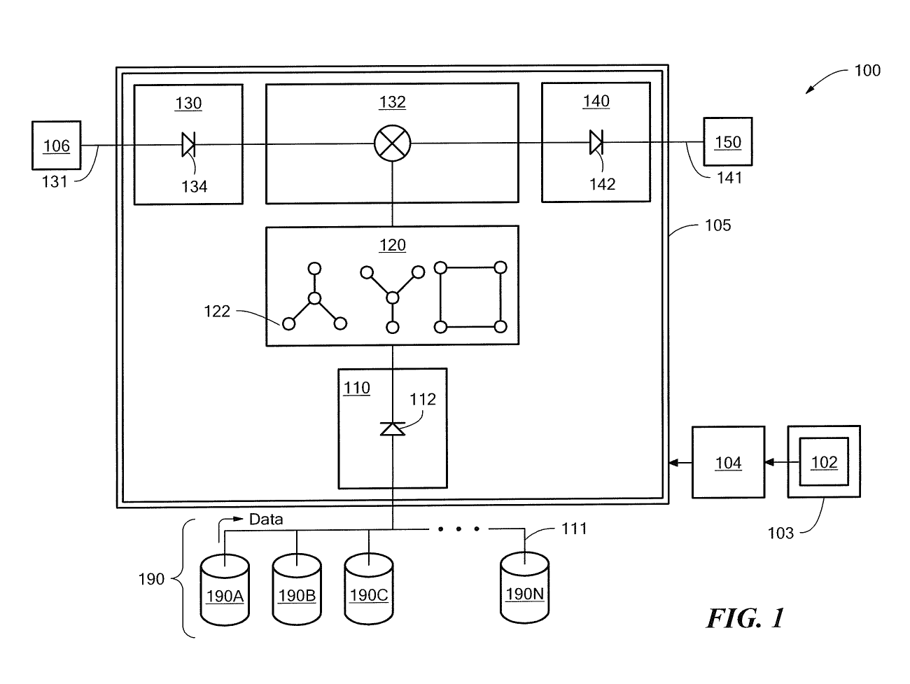

Referring to FIG. 1, in one aspect, apparatus 100 for information privacy assurance includes data processing engine 105 to restrict access to data received from plurality of data sources (generally designated by reference numeral 190) and to predefined data relationship query 106. Data processing engine 105 includes data input component 110 restricted to receive the data from plurality of data sources 190 (e.g. data sources 190A, 190B, 190C-190N) and data relationship component 120 configured to generate data relationships (generally designated by reference numeral 122) associated with the data. Data processing engine 105 also includes query input component 130 restricted to receive predefined data relationship query 106 associated with data relationships 122, query execution component 132 configured to execute predefined data relationship query 106, and data output component 140 restricted to render result 150 including information associated with an execution of predefined data relationship query 106.

In some embodiments, apparatus 100 includes instructions 102 stored in memory 103 that when loaded into and executed by processor 104 enable data processing engine 105 for information sharing and privacy assurance. Apparatus 100 may include software and/or hardware components to enable various features of data processing engine 105. For example, hardware bus adapters may be configured with a unidirectional data protocol to enable the hardware bus adapter to receive data, but not transmit data.

In a further embodiment, data input component 110 includes unidirectional network controller 112 configured to receive data over network 111 and to block access to the data on data processing engine 105. Various methods may be used to implement unidirectional network controller 112. For example, data diodes such as those described in the Background section of the present application may be used to restrict and/or block access to the data over network 111 from outside data processing engine 105. Other methods include software and/or hardware techniques such as a data driver with privileged access to a protected memory. Here, data processing engine 105 may be altered such that only the data driver has read/write permissions the protected memory. Other processes such as those executing on data processing engine 105 and/or including those which may enable network communications (i.e., port protocol programs which transmit and/or receive data over a network link) are unable to read/write to the protected memory. In some instances, data processing engine 105 includes an operating system that may be altered to eliminate or disable certain preprogrammed functionality and/or features to eliminate access to the data.

It should be noted that methods used to restrict access to the data on data processing engine 105 may vary in scope and integrity based upon the information sharing and privacy assurance needs (which may vary from time-to-time) and acceptable levels of risk of data exposure. For example, some applications may require a relatively high level of information privacy protection and so a rigorous software and/or hardware implementation such as data diodes may be used to restrict and/or block access to the data. However, such highly restrictive methods may be overly restrictive from time-to-time such as when an organization needs to access (or provide access to) the data. For example, military organizations and/or government entities may need to declassify documents which were formally classified so that the documents become available to the public (e.g., under the principle of freedom of information). In such a case, data input component 110 is configured to restrict and/or block access to the data up until the time the data becomes declassified.

It should also be noted that other components of data processing engine 105 may also include a unidirectional network controller which may be the same or similar to unidirectional network controller 112 described above in conjunction with data input component 110. More particularly, query input component may include unidirectional network controller 134 configured to receive predefined data relationship query 106 over network 131 and to block access to predefined data relationship query 106 on data processing engine 105. Furthermore, in the same or different embodiment, data output component 140 may include unidirectional network controller 142 configured to render result 150 over network 141 and to block access to result 150 on data processing engine 105. Here, data output component 140 is configured to render result 150 only to an authorized recipient and restricts and/or blocks access to result 150 to all other (unauthorized) recipients.

In some embodiments, data input component 110 is configured to receive data from one or more data sources 190. Data sources 190 may include those used by one or more organizations which contribute data to data processing engine 105. Here, data input component 110 restricts access to the data, while the data may be exploited by various organizations to render desired information, such as information associated with suspects fitting a particular criminal and/or terrorist profile.

For example, data input component 110 may receive information from a local law enforcement agency (e.g., arrest records, witness reports, suspect attributes, etc.) via first data source 190A, a retail chain (e.g., customer information, purchasing behavior, items purchased, point-of-sale locations) via second data source 190B, a border security agency (e.g., border crossings, vehicle information, passenger registers, etc.) via third data source 190C, etc. up to N data sources (i.e., 190N) depending on a number of contributing organizations. Advantageously, data processing engine 105 enables the data to remain private while allowing these organizations to execute certain authorized queries on the data to render useful information.

In a further embodiment, data input component 110 receives data from an authorized data source, which may include receiving data generated according to predefined data protocols which are used to validate the data source and verify the data format. For example, data input component 110 may receive data related to suspicious activity (e.g., suspicious purchases that may be related to bomb-making activity, a particular example of which is described below) from a first authorized data source and a second authorized data source. The first authorized data source may be associated with a first retailer who transfers purchasing information to the first authorized data source, and the second authorized data source may be associated with a second retailer who transfers purchasing information to the second authorized data source. The first and/or second retailers may generate the data using one or more predefined data protocols, for example, an extensible markup language (XML) format that defines data entities and data entity attributes. In some embodiments, data input component 110 receives the data over an encrypted network (i.e., the data is encrypted).

In the same or different embodiment, data relationship component 120 receives data from data input component 110 and generates data relationships 122. In some embodiments, data relationship component 120 uses an ontology model to define data attributes and data relationships. For example, the ontology model may include data attributes/relationships to define a problem domain and/or context, such as investigations related to suspicious activity indicative of terrorist activity in order to thwart or mitigate the consequences of such activity. It should be appreciated, however, that an ontology model can represent most any problem domain and/or context, for example, a military theatre to track military operations (e.g., troop positions, enemy targets, etc.), a border crossing context in which it is desired track border crossing events (e.g., known suspects and/or tracked vehicles crossing into or out of the United States), a business context in which multiple organizations need to exploit each other's confidential data (e.g., by querying the data to render useful information) without necessarily divulging the data to other organizations. It should also be appreciated that data relationship component 120 may generate the ontology model and/or receive ontology model definitions from an outside source.

In another embodiment, query input component 130 receives predefined data relationship query 106 from an authorized query source. For example, query input component 130 may receive predefined data relationship query 106 related to suspicious activity (as may be the same or similar to suspicious purchases related to bomb-making activity mentioned above) from an organization authorized to generate queries associated with a certain problem domains. For example, an elected or appointed bipartisan committee of government officials (which may be referred to as “a policy body”) may generate vetted queries to investigate criminal activity based on reasonable suspicion standards. More particularly, these government officials (who may be lawyers with a background in criminal and/or constitutional law) may have an understanding of preexisting factors which may be necessary to authorize a search of otherwise private/protected information of a personal nature. Such rights may differ by jurisdiction (e.g., state, federal, international, and/or treaty-based rights, international law such as privacy statutes in Europe). In some embodiments, query input component 130 receives predefined data relationship query 106 over an encrypted network (i.e., predefined data relationship query 106 is encrypted).

In the same or different embodiment, query execution component 132 receives predefined data relationship query 106 from query input component 130 and executes query 106 against data relationships 122 defined by data relationship component 120. Various methods may be used to execute query 106. For example, predefined data relationship query 106 may be associated with a structured database query that uses a structured query language (SQL) to query a database. Here, data relationships 122 may be defined and organized using a database and more particularly, using a database engine. In this way, the SQL query includes criteria to search the database and, more particular, uses criteria to search database records that match the desired criteria and to return the matching database records.

In a further embodiment, data output component 140 renders result 150 of query execution component 132 to one or more outside organizations authorized to receive result 150. For example in the United States, a law enforcement agency including, but not limited to, a local or state investigative agency, the Federal Bureau of Investigations (FBI), the Central Intelligence Agency (CIA), and other organizations may be authorized to receive a result including information related to suspects who may be involved in criminal and/or terrorist activities, such as bomb-making. These organizations may need to search for, investigate, respond to, and/or mitigate criminal activity.

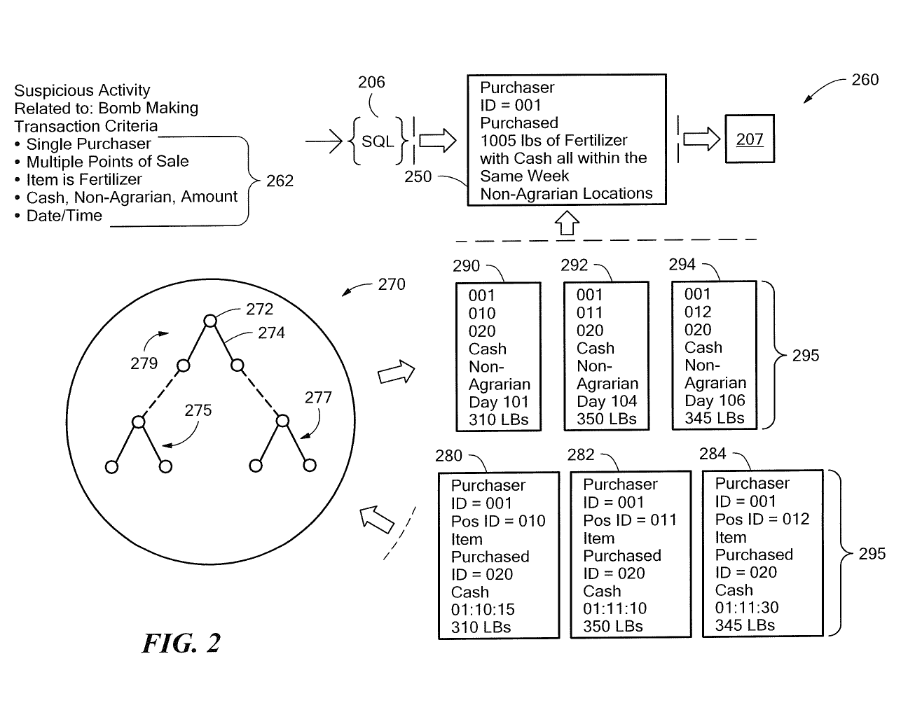

Referring now to FIG. 2 and again to FIG. 1, one particular example of a information sharing and privacy assurance application of the type which may incorporate the inventive concepts, systems, and techniques described herein is directed to a problem domain or context related to terrorism. In this particular example, ontology model 270 is used to track suspicious activity related to terrorist acts. For example, the suspicious activity may include bomb-making activity by terrorist agents who collect bomb-making materials such as fertilizer (and, in particular, ammonium nitrate in fertilizer) to build bombs for deployment and detonation against civilians.

Organizations may generate definitions of the bomb-making activity and, in particular, natural language definition 260 that includes criteria and relationships which tend to reveal and/or suggest bomb-making activity or prompt a reasonable suspicion that a suspect is engaged in (or about to engage in) bomb-making activity. Natural language definition 260 may include transaction criteria (generally designated by reference numeral 262) identified by an authorized query source (as may be the same or similar to the authorized query source described in conjunction with FIG. 1). The authorized query source may represent one or more persons with an understanding of certain kinds of behavior indicative of terrorist activity and/or which include factors prompting a reasonable suspicion of certain kinds of terrorist activity.

For example, the authorized query source may define bomb-making transaction criteria 262 which identify a single purchaser who uses cash to purchase fertilizer at more than one non-agrarian point-of-sale location. Also, transaction criteria 262 may identify date/time and/or time intervals between purchases as well as a total amount of purchased fertilizer (e.g., 1000 pounds of fertilizer needed to build a certain kind of bomb). The authorized query source may convert transaction criteria 262 into predefined data relationship query 206 which, in some embodiments, includes query information (e.g., a description of an SQL query) received by query input component 130.

Ontology model 270 includes nodes 272 and node linkages 274 to define data entities and relationships between the data entities. For example, ontology model 270 can include first graph 275 representing a purchaser, second graph 277 representing a point-of-sale location, and third graph 279 representing a relationship between first and second graph 275, 277 such as an item purchased by a purchaser (as represented by first graph 275) at a point-of-sale location (as represented by second graph 277). First, second, and third graphs 275, 277, 279 may also include attribute data related to the purchaser (such as a unique purchaser identifier, purchaser name, residential address, criminal record, etc.), the point-of-sale location (such as a point-of-sale unique identifier, name, address, product inventory, etc.), and the item purchased (such as an item unique identifier, item units, type of transaction, type of location, etc.). A specific instance of third graph 279 (in this particular example) may include more detailed purchasing data related to bomb-making activity such as an amount of fertilizer purchased, whether or not the purchase was in cash, whether or not the purchase was at an agrarian point-of-sale location (i.e., proximate to or located on agricultural land), etc.

Contributing organizations transfer instances of problem domain data (generally designated by reference numeral 285) to data input component 120 via data sources 103. More particularly, a retail organization (for example, a garden supply store, a hardware supplier, etc.) may provide purchasing information to the authorized data source that may include a purchaser identifier (ID), a point-of-sale (POS) ID, an item purchased ID, a type of transaction (e.g., cash, credit, check, etc.) and other relevant information. Data relationship component 120 processes the data using ontology model 270 to generate data relationships (generally designated by reference numeral 295).

In some embodiments, data relationship component 120 includes an ontology module that generates ontology model 270 as well as instances of ontology model 270. The ontology module may include software, hardware, or a combination thereof. For example, a set of software modules (as may be the same or similar to software 102) which use object-oriented programming techniques may data objects (i.e., data classes which include attributes and relationships) and data behaviors (i.e., data class methods). In other embodiments, a data structure such as a linked list and/or an array may be used to define data entities. A processor (as may be the same or similar to processor 104) processes the data to generate instances of the data relationships. Processor 104 may use a memory (as may be the same or similar to memory 103) to store the data and the data relationships.

With continued reference to the example related to suspicious activity, data input component 110 may receive first fertilizer purchase record 280 via first authorized data source 190A, second fertilizer purchase record 282 via second authorized source 190B, and third fertilizer purchase record 284 via third authorized source 190C. Data relationship component 120 generates instances of ontology model 270 using the data records. In particular, data relationship component 120 generates first instance 290 to describe a first fertilizer purchase by a purchaser at a first point-of-sale, second instance 292 to describe a second fertilizer purchase by the purchaser at a second point-of-sale, and third instance 294 to describe a third fertilizer purchase by the purchaser at a third point-of-sale. As can be seen in FIG. 2, first, second, and third instances 290, 292, 294 are indicative of a total of about 1000 pounds of fertilizer purchased by the purchaser. Also, the purchaser used cash and completed the purchases with the same week at non-agrarian locations.

Query execution component 132 receives predefined data relationship query 206 (which may include query information used generate a data query), executes query 206 with reference to instances of the ontology model 290, 292, 294, and obtains query result 250 which data output component 140 renders to organizations 207. In particular, result 250 which may include one or more data descriptions associated with first, second, and third purchases 280, 282, 284 (e.g., purchaser's name, address, the type of suspect activity, etc.) As by way of a non-limiting example, an organization 207 may include a legal body that reviews result 250 to verify whether or not result 250 constitutes a reasonable suspicion and may forward related information to law enforcement agencies to monitor, track, investigate, capture, and/or arrest suspected terrorists.

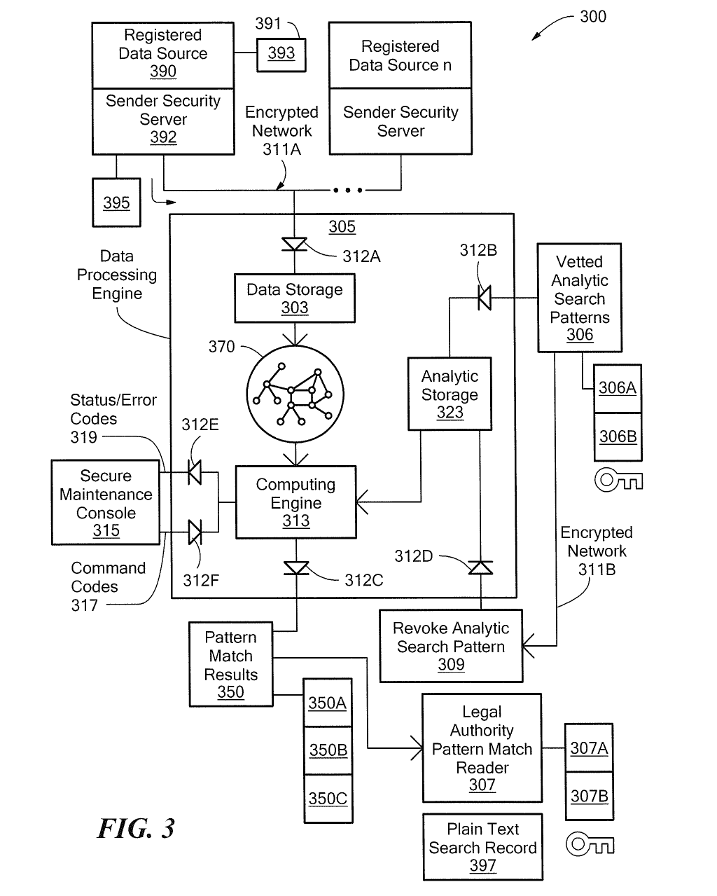

Referring now to FIG. 3, an embodiment of information sharing and privacy assurance apparatus 300 (hereinafter referred to as “the information privacy apparatus”) includes data processing engine 305, registered data sources 390, sender security services 392 which guarantee certified data delivery and preservation of data rights (e.g., rights associated with a data owner such as a right to generate the data), and vetted analytical search patterns 306. Information privacy apparatus 300 also includes pattern match results 350, legal authority pattern match reader 307, secure maintenance console 315, encrypted network link 311A to enable encrypted data communications between registered data sources 390 and data processing engine 305, and encrypted network link 311B to enable encryption of vetted analytical search patterns 306.

Data processing engine 305 includes plurality of unidirectional network controllers 312A-F, data storage component 303, computing engine 313, analytic storage component 323, and data relationship model 370.

Information privacy apparatus 300 is configured to provide information sharing and privacy assurance to enforce legal uses of data stored on data processing engine 305. More particularly, data processing engine 305 is configured to provide secure storage of data, which may include assurances that data received from data sources 390 is registered to legal owners of the data. Furthermore, information privacy apparatus 300 is configured to execute vetted (i.e., examined, evaluated, and verified) analytic search patterns 306 thereby preventing illegal or illegitimate uses of the data including, but not limited to, those which violate privacy laws or policies. Data processing engine 305 is configured to render pattern match results 350 restricted to being received by legal authorities 307 based on a vetted analytic search pattern identifier.

In further embodiments, secure maintenance console 315 is configured to maintain information privacy apparatus 300. Optionally, secure maintenance console 315 is configured to send predefined command codes 317 to data processing engine 305 and to receive predefined status and error codes 319 from data processing engine 305 to render data access errors and/or unauthorized data access attempts including, but not limited to, data source attempts to access the data, attempts by organizations to access vetted analytic search patterns 306, and/or attempts by legal authority pattern match readers 307 to access pattern match results 350.

In some embodiments, vetted analytic search patterns 306 are configured to search for patterns in the data (e.g., patterns of activity or matches across one or more sets of data) without providing access to the data. Optionally, candidate search patterns are reviewed by legal, civil rights, justice and/or privacy experts (i.e., policy bodies) who certify the validity and/or significance of candidate search patterns. Vetted search patterns 306 may include search pattern identifier 306A and search results encryption key 306B used to encrypt pattern match results 350 such that only organizations in possession of search results encryption key 306B may access pattern match results 350. For example, legal authority pattern match reader 370 can use copy of search results encryption key 307B to decrypt contents of pattern match results 350.

In the same or different embodiment, information privacy apparatus 300 includes revoke analytic search pattern component 309 configured to revoke and/or remove vetted search pattern 306. In particular, revoke analytic search pattern component 309 can receive a command to revoke vetted search pattern 306. For example, as laws are enacted and/or repealed and policies change, vetted search pattern 306 may become forbidden by law, disallowed by policy or produce pattern match results 350 that are no longer legally allowed. Revoke analytic search pattern 309 may receive search pattern identifier 306A and legal authority identifier 307A to identify particular vetted search pattern 306 for revocation. In such an instance, data processing engine 305 may remove any accumulated (or intermediate) pattern match results 350. In a further embodiment, secure maintenance console 315 receives predefined status code 319 that identifies that vetted search pattern 306 has been revoked and/or removed.

In a particular exemplary operation of information privacy apparatus 300, data processing engine 305 receives data from registered data sources 390 over unidirectional network controller 312A and stores the data in data storage 303. Unidirectional network controller 312A restricts access to the stored data, which may include blocking access to the data over network 311A from outside data processing engine 305. Registered data sources 390 include, but are not limited to, data sources associated with law enforcement agencies, private companies, intelligence agencies, federal government agencies, public record bodies, and open source information such as newspapers, websites and broadcasts.

Data processing engine 305 may optionally include ontology model 370 (as may be the same or similar to ontology model 270 described in conjunction with FIG. 2) to define data entities and data relationships and, in particular, data entities and relationships associated with a problem domain or a context. Instances of the data may be generated and structured using ontology model 370.

Data processing engine 305 receives one or more vetted search patterns 306 over unidirectional network controller 312B and stores vetted search patterns 306 in analytic storage 323. Unidirectional network controller 312B restricts access to stored vetted search patterns 306, which may include blocking access to vetted search patterns 306 from sources outside data processing engine 305.

Computing engine 313 executes vetted search patterns 306, which may include scanning for any new or modified vetted search patterns 306. Computing engine 313 may execute vetted search patterns 306 at predefined time intervals. Computing engine 313 executes vetted search patterns 306 against instances of the ontology model 370 and renders pattern match results 350 over unidirectional network controller 312C to legal authority pattern match reader 307. Unidirectional network controller 312C restricts access to pattern match results 350, which may include blocking access to pattern match results 350 to sources other than legal authority pattern match reader 307.

Pattern match results 350 may include vetted search pattern identifier 350A (which may be the same or similar to vetted search pattern identifier 306A), result record body 350B which includes the pattern results content, and match reason 350C which includes information related to why a particular vetted search pattern 306 yielded pattern match results 350 and/or particular reasons for executing search pattern 306 (e.g., vetted search pattern 306 may have been executed as part of a particular effort to thwart a terrorist cell). Legal authority pattern match reader 307 receives pattern match results 350 and legal authority having access to legal authority pattern match reader 307 may review, provide a legal disposition, and/or recommend actions based on pattern match results 350 for certain organizations including, but not limited to, law enforcement, Department of Justice, intelligence agencies, and/or the Department of Homeland Security.

The legal authority may optionally request search results encryption key 307B associated with vetted search pattern 306 (and, more particularly, to vetted search pattern identifier 306A) for use in decrypting pattern match result 350 (and, more particularly, result record body 350B) to generate plan text search record 397 that may be read along with match reason 350C. The legal authority, for example, may act on the information to obtain a search warrant (e.g., a search warrant that a law enforcement agency may use to legally search a suspect's residence for criminal evidence). In this way, information privacy apparatus 300 can help organizations exploit data of a private nature in a way that meets or exceeds certain legal requirements.

Optionally, an owner of registered data source 390 can define data record contents source template 391 that includes metadata description 393 of data record 395 sent to data processing engine 305. Metadata description 393 includes information such as whether or not data record 395 can be used to uniquely identify, contact, and/or locate a person or can be used with other sources to uniquely identify an individual.

In these embodiments, data record contents source template 391 may be managed by a group of owners to enable collection, parsing, and transmission of data to data processing engine 305. Sender security service 392 encrypts the data and passes the data to data processing engine 305 via unidirectional network controller 312A Owners may request an audit report for statistics on data received by data processing engine 305 for a specified period of time. Data processing engine 305 generates the audit information and renders it to secure maintenance console 315.

In still other embodiments, data processing engine 305 receives a request to delete data stored on data processing engine 305. For example, data processing engine 305 can receive a request from an owner of registered data source 390 to delete data records to comply with changes in law, policy or legal retention restrictions. Data processing engine 305 deletes the data and reports the data deletion to secure maintenance console 315.

In some embodiments, secure maintenance console 315 receives diagnostic information from data processing engine 305 and performs maintenance on data processing engine 305 in a way that reduces and/or eliminates unauthorized access to data processing engine 305. One particular way to accomplish this is through the use of predefined status codes 319 and predefined command codes 317 which define and restrict message prompts from and allowed interactions with data processing engine 305.

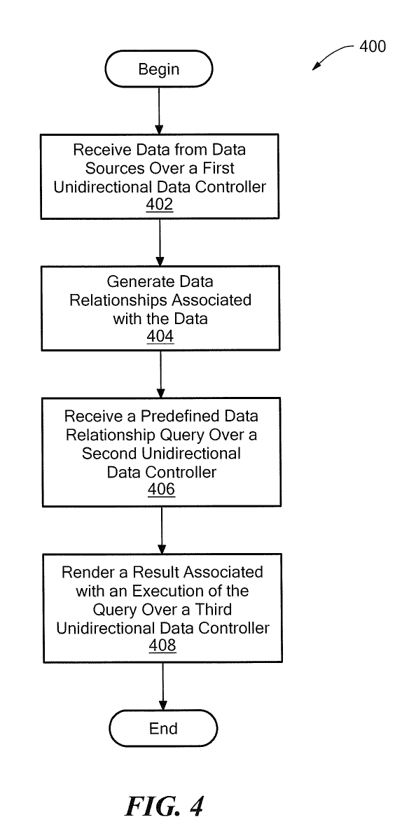

Referring now to FIG. 4, a method 400 for information sharing and privacy assurance includes, at 402, receiving data from a plurality of data sources over a first unidirectional network controller, at 404, generating data relationships associated with the data, at 406, receiving a predefined data relationship query associated with the data relationships over a second unidirectional network controller, and, at 408, rendering a result associated with an execution of the predefined data relationship query over a third unidirectional network controller.

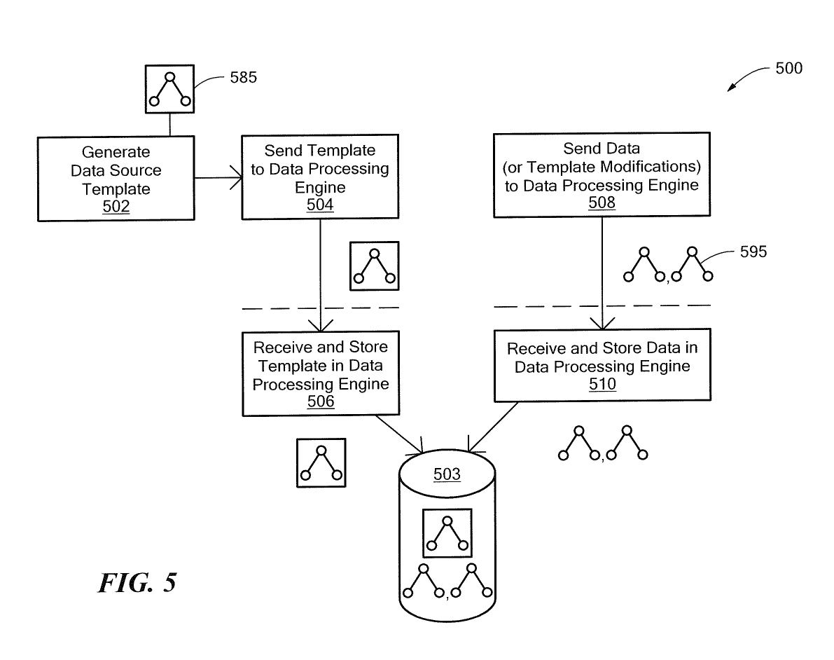

Referring now to FIG. 5, in a further embodiment a method 500 for defining a data source (as may be the same or similar to one or more of the registered data sources 390 described in conjunction with FIG. 3) includes, at 502, generating template 585 for data records in the data source and, at 504 sending template 585 to a data processing engine over a unidirectional network controller (as may be the same or similar to data processing engine 305 and unidirectional network controller 312A described in conjunction with FIG. 3). At 506, the data processing engine receives template 585 and stores it in data storage 503. The data processing engine uses template 585 to process data received from the data source.

Template 585 can include a data source identifier to identify the data source, an owner identifier to identify an owner of the data source, and a data schema including, but not limited to, a extensible markup language schema and/or a database schema to define data concepts and data relationships. Optionally, a security server (as may be the same or similar to sender security server 392 described in conjunction with FIG. 3) sends template 585 to the data processing engine over an encrypted network.

In still a further embodiment, at 508, the data source sends data 595 (including data records) to the data processing engine over the unidirectional network controller and, at 510, the data processing engine receives and stores data 595 in data storage 503. The sender security server may parse data 595 into data records, each having a data record identifier, and encrypt the data records for transmission over the network. The data processing engine receives and stores the data records, which can include storing the data source identifier, the owner identifier and other information.

The method may further include modifying data source template 585 and storing changes to template 585 in data storage 503. In one particular example, a data source may include information related to commercial airline passenger records. For example, an airline carrier may retain detailed passenger records for 72 hours after a flight has terminated. Here, the data processing engine processes the passenger records to remove them after 72 hours. However, a new bilateral agreement between the United States and another country may require passenger records to be terminated 42 hours after flight termination. Here, the data processing engine receives a modified template to remove passenger records after 42 hours, performs the modification to the stored template, and may send a predefined status code to a secure maintenance console over a unidirectional network controller (as may be the same or similar to predefined status code 319, secure maintenance console 315, and unidirectional network controller 312E described in conjunction with FIG. 3). Predefined status code 319 may include a data source identifier and/or an owner identifier associated with the data source, the data source owner, and the template.

In other non-limiting examples, the data schema may be modified and/or a particular data record may be modified, for example, to designate the data record as one including personally identifiable information.

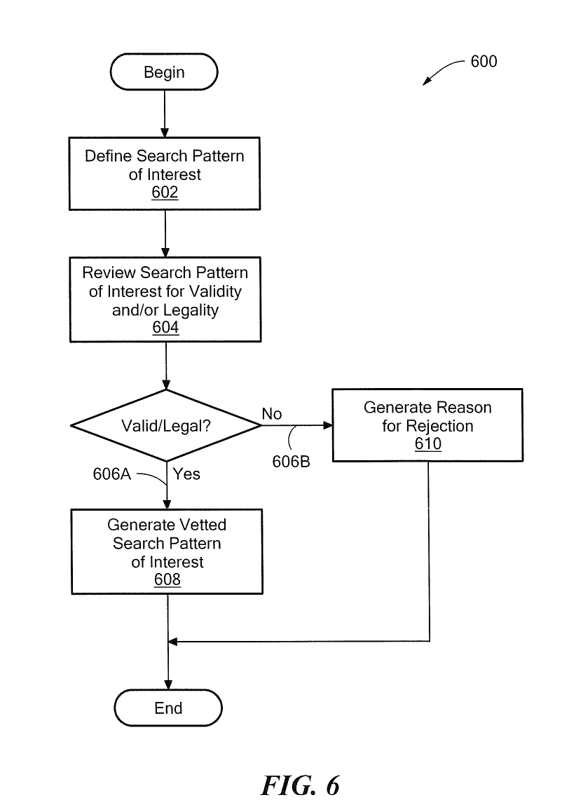

Referring now to FIG. 6, in another embodiment a method 600 for generating a vetted analytic search pattern (as may be the same or similar to vetted analytic search patterns 306 described in conjunction with FIG. 3) includes, at 602, defining a search pattern of interest and, at 604, reviewing the search pattern of interest for validity and/or legality, including adding a reviewer key to identify a search pattern of interest reviewer.

The method further includes, at 608, generating a vetted analytic search pattern 608 in response to an approved search pattern of interest at 606A. Optionally, the vetted analytic search pattern is sent to a data processing engine via a unidirectional network controller (as may be the same or similar to data processing engine 350 and unidirectional network controller 312B described in conjunction with FIG. 3). The unidirectional network controller is configured to restrict and/or block access to the vetted analytic search pattern on the data processing engine.

In still another embodiment, if the search pattern of interest is rejected at 606B, the method 400 includes, at 610, generating information related to the rejected search pattern of interest, such as information related to why the search pattern of interest was rejected, and the reviewer key.

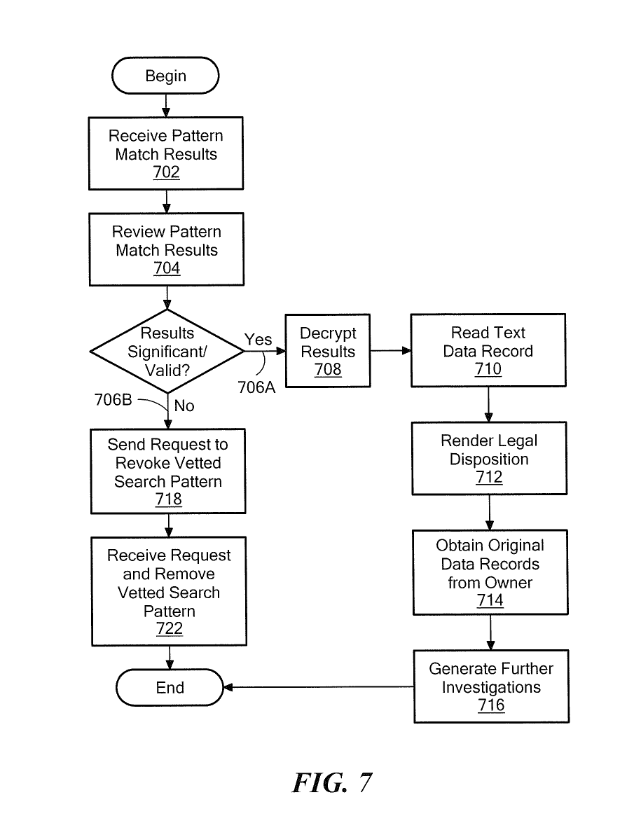

Referring now to FIG. 7, in a further embodiment a method 700 for reviewing pattern match results (as may be the same or similar to pattern match results 350 described in conjunction with FIG. 3) includes, at 702, receiving pattern match results from a data processing engine over a unidirectional network controller (as may be the same or similar to data processing engine 305 and unidirectional network controller 312C described in conjunction with FIG. 3) and, at 704, reviewing the pattern match results for significance and/or validity (e.g., whether or not the pattern match results are related to a high-priority investigation and/or whether or not the pattern match results represent stale (i.e. out-dated) information, etc.). At 706A, if the pattern match results are significant/valid then, at 708, the results are decrypted (e.g., using an encryption key, such as key 3068 described in conjunction with FIG. 3) and, at 710, the decrypted text is reviewed. Based on the review (e.g., a review conducted by a legal authority), at 712, a legal disposition is rendered. The method 700 may further include, at 714, obtaining original data records from an owner of the data source and/or, at 716, generating further investigations based on the legal disposition including, but not limited to, issuing a search warrant, opening a new criminal investigation, producing procedures to thwart suspected terrorist activity, etc.

At 706B, if the pattern match results are insignificant/invalid, then the method 700 may include, at 718, sending a request to revoke the vetted search pattern that initiated the pattern match results and, at 720, receiving the request at the data processing engine. The data processing engine removes the vetted search pattern and, optionally, sends a predefined status code to a secure maintenance console over a unidirectional network controller (as may be the same or similar to predefined status code 319, secure maintenance console 315, and unidirectional network controller 312E described in conjunction with FIG. 3). Predefined status code 319 may include a vetted pattern search identifier and an author identifier.

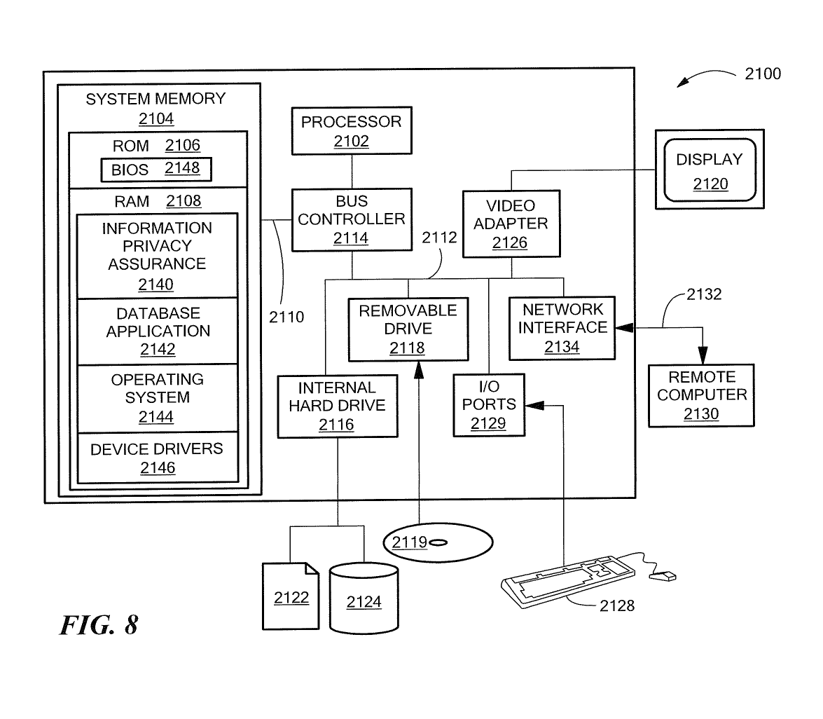

FIG. 8 illustrates a computer 2100 suitable for supporting the operation of an embodiment of the inventive systems, concepts, and techniques described herein. The computer 2100 includes a processor 2102, for example, a desktop processor, laptop processor, server and workstation processor, and/or embedded and communications processor. As by way of a non-limiting example, processor 2102 may include an Intel® Core™ i7, i5, or i3 processor manufactured by the Intel Corporation of Santa Clara, Calif. However, it should be understood that the computer 2100 may use other microprocessors. Computer 2100 can represent any server, personal computer, laptop, or even a battery-powered mobile device such as a hand-held personal computer, personal digital assistant, or smart phone.

Computer 2100 includes a system memory 2104 which is connected to the processor 2102 by a system data/address bus 2110. System memory 2104 includes a read-only memory (ROM) 2106 and random access memory (RAM) 2108. The ROM 2106 represents any device that is primarily read-only including electrically erasable programmable read-only memory (EEPROM), flash memory, etc. RAM 2108 represents any random access memory such as Synchronous Dynamic Random Access Memory (SDRAM). The Basic Input/Output System (BIOS) 2148 for the computer 2100 is stored in ROM 2106 and loaded into RAM 2108 upon booting.

Within the computer 2100, input/output (I/O) bus 2112 is connected to the data/address bus 2110 via a bus controller 2114. In one embodiment, the I/O bus 2112 is implemented as a Peripheral Component Interconnect (PCI) bus. The bus controller 2114 examines all signals from the processor 2102 to route signals to the appropriate bus. Signals between processor 2102 and the system memory 2104 are passed through the bus controller 2114. However, signals from the processor 2102 intended for devices other than system memory 2104 are routed to the I/O bus 2112.

Various devices are connected to the I/O bus 2112 including internal hard drive 2116 and removable storage drive 2118 such as a CD-ROM drive used to read a compact disk 2119 or a floppy drive used to read a floppy disk. The internal hard drive 2116 is used to store data, such as in files 2122 and database 2124. Database 2124 includes a structured collection of data, such as a relational database. A display 2120, such as a cathode ray tube (CRT), liquid-crystal display (LCD), etc. is connected to the I/O bus 2112 via a video adapter 2126.

A user enters commands and information into the computer 2100 by using input devices 2128, such as a keyboard and a mouse, which are connected to I/O bus 2112 via I/O ports 2129. Other types of pointing devices that may be used include track balls, joy sticks, and tracking devices suitable for positioning a cursor on a display screen of the display 2120.

Computer 2100 may include a network interface 2134 to connect to a remote computer 2130, an intranet, or the Internet via network 2132. The network 2132 may be a local area network or any other suitable communications network.

Computer-readable modules and applications 2140 and other data are typically stored on memory storage devices, which may include the internal hard drive 2116 or the compact disk 2119, and are copied to the RAM 2108 from the memory storage devices. In one embodiment, computer-readable modules and applications 2140 are stored in ROM 2106 and copied to RAM 2108 for execution, or are directly executed from ROM 2106. In still another embodiment, the computer-readable modules and applications 2140 are stored on external storage devices, for example, a hard drive of an external server computer, and delivered electronically from the external storage devices via network 2132.

The computer-readable modules 2140 may include compiled instructions for implementing embodiments directed to information sharing and privacy assurance described herein. In a further embodiment, the computer 2100 may execute information sharing and privacy assurance on one or more processors. For example, a first processor for generating data relationships (as may be the same or similar to data relationships 122 described in conjunction with FIG. 1 and/or ontology model 370 described in conjunction with FIG. 3) and a second processor for query execution (as may be the same or similar to query execution component 132 described in conjunction with FIG. 1). Furthermore, the first and second processors may be respective processors of a dual-core processor. Alternatively, the first and second processor may respective first and second computing devices.

The computer 2100 may execute a database application 2142, such as Oracle™ database from Oracle Corporation, to model, organize, and query data stored in database 2124. The data may be used by the computer-readable modules and applications 2140 information associated with the data (e.g., information associated with search patterns) may be rendered over the network 2132 to a remote computer 2130 and other systems.

In general, the operating system 2144 executes computer-readable modules and applications 2140 and carries out instructions issued by the user. For example, when the user wants to execute a computer-readable module 2140, the operating system 2144 interprets the instruction and causes the processor 2102 to load the computer-readable module 2140 into RAM 2108 from memory storage devices. Once the computer-readable module 2140 is loaded into RAM 2108, the processor 2102 can use the computer-readable module 2140 to carry out various instructions. The processor 2102 may also load portions of computer-readable modules and applications 2140 into RAM 2108 as needed. The operating system 2144 uses device drivers 2146 to interface with various devices, including memory storage devices, such as hard drive 2116 and removable storage drive 2118, network interface 2134, I/O ports 2129, video adapter 2126, and printers.

Having described preferred embodiments which serve to illustrate various concepts, structures and techniques which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims.

What is claimed is:

1. An apparatus for information privacy assurance, comprising:
a data processing engine to restrict access to data received from a plurality of data sources and to a predefined data relationship query, comprising:
a data input component restricted to receive the data from the plurality of data sources;
a data relationship component configured to generate data relationships associated with the data;
a query input component restricted to receive the predefined data relationship query associated with the data relationships;
a query execution component configured to execute the predefined data relationship query; and
a data output component restricted to render a result including information associated with an execution of the predefined data relationship query.

2. The apparatus of claim 1, wherein the data input component includes a unidirectional network controller configured to receive data over a network and to block access to the data on the data processing engine.

3. The apparatus of claim 2, wherein the data is received from an authorized data source.

4. The apparatus of claim 1, wherein the plurality of data sources generate the data according to predefined data protocols.

5. The apparatus of claim 1, further comprising an ontology model to define concepts and relationships associated with the data, wherein the data relationship component is configured to associate the data with the ontology model.

6. The apparatus of claim 1, wherein the query input component includes a unidirectional network controller configured to receive information associated with the predefined data relationship query over a network and to block access to the information on the data processing engine.

7. The apparatus of claim 1, wherein the predefined data relationship query is received from an authorized query source.

8. The apparatus of claim 1, wherein the data output component includes a unidirectional network controller configured to render the result over a network and to block access to the result on the data processing engine.

9. A method for information sharing and privacy assurance comprising:
receiving data from a plurality of data sources over a first unidirectional network controller;
generating data relationships associated with the data;
receiving a predefined data relationship query associated with the data relationships over a second unidirectional network controller; and
rendering a result including information associated with an execution of the predefined data relationship query over a third unidirectional network controller.

10. The method of claim 9, wherein the first unidirectional network controller is configured to block access to the data over a network.

11. The method of claim 10, wherein the data is received from an authorized data source.

12. The method of claim 9, wherein the plurality of data sources generates the data according to predefined data protocols.

13. The method of claim 9, further comprising:
generating an ontology model to define concepts and relationships associated with the data.

14. The method of claim 9, wherein the second unidirectional network controller is configured to block access to the predefined data relationship query over a network.

15. The method of claim 9, wherein the predefined data relationship query is received from an authorized query source.

16. The method of claim 9, wherein the third unidirectional network controller is configured to block access to the result over a network.

17. A computer readable medium having encoded thereon software for information privacy assurance, said software comprising instructions that when executed by a processor enable:
receiving data from a plurality of data sources over a first unidirectional network controller;
generating data relationships associated with the data;
receiving a predefined data relationship query associated with the data relationships over a second unidirectional network controller; and
rendering a result associated including information with an execution of the predefined data relationship query over a third unidirectional network controller.

18. The computer readable medium of claim 17, wherein the software further comprises instructions for:
configuring the first unidirectional network controller to block access to the data over a network.

19. The computer readable medium of claim 17, wherein the software further comprises instructions for:
receiving the data from an authorized data source.

20. The computer readable medium of claim 17, wherein the software further comprises instructions for:
generating an ontology model to define concepts and relationships associated with the data.

21. The computer readable medium of claim 17, wherein the software further comprises instructions for:
configuring the second unidirectional network controller to block access to the predefined data relationship query over a network.

22. The computer readable medium of claim 17, wherein the software further comprises instructions for:
receiving the predefined data relationship query from an authorized query source.

23. The computer readable medium of claim 17, wherein the software further comprises instructions for:
configuring the third unidirectional network controller to block access to the result over a network.
